(19) United States
(12) Patent Application Publication
(10) Pub. No.: US 2008/0125114 A1
(43) Pub. Date: May 29, 2008

(54) METHOD AND SYSTEM FOR REGISTERING MULTIPLE ADDRESSES OF RECORD FOR A MOBILE STATION

(75) Inventor: Jheroen P. Dorenbosch, Paradise, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/563,364

(22) Filed: Nov. 27, 2006

(51) Int. Cl. H04Q 7/20

(52) U.S. Cl. 455/433

(57) ABSTRACT

A method and system for registration of an MS with a home communication network of the MS when the MS roams into a visited communication network is provided. The method includes communicating a register message from the visited communication network to the home communication network. The register message is a Session Initiation Protocol (SIP) register request and includes each of a primary AoR and one or more secondary AoRs. The method further includes registering the primary AoR and one or more secondary AoRs with the home communication network.

### FIELD OF THE PRESENT INVENTION

The present invention generally relates to communication services for Mobile Stations (MSs) in communication networks. More specifically, the present invention relates to registering multiple Addresses of Record (AoRs) of an MS with a home communication network when the MS roams into a visited communication network.

### BACKGROUND OF THE PRESENT INVENTION

In communication systems, when an MS roams from a home communication network to a visited communication network, the user of the MS may desire to continue the connectivity of the MS with the home communication network. For example, the home communication network can be an Integrated Digital Enhanced Network (iDEN™) communication network and the visited communication network can be one of an iDEN™ communication network and a Third Generation (3G) communication network. To continue the connectivity with the home communication network, the MS registers with the home iDEN™ communication network when the MS is in the visited communication network.

The MS may be using a primary Identifier (ID) and a secondary ID in the home communication network. The primary ID, for example, may be an International Mobile Subscriber Identifier (IMSI) and a secondary ID, for example, may be one of a Universal Fleet Member Identifier (UFMI), a fleet Identifier (ID) and an International Mobile Equipment Identity (IMEI). In this case, in order to maintain connectivity with the home communication network and to utilize communication service provided by the home communication network while roaming in the visited communication network, the MS is required to register the primary ID and all of the secondary IDs with the home communication network. In some visited communication networks, such as a 3G communication network, a primary Address Of Record (AoR) is used and corresponds to the primary ID to identify the MS and a secondary AoR is used and corresponds to the secondary ID.

When the MS roams into the visited communication network, the MS or a gateway of the visited communication network and the home communication network of the MS may communicate authentication messages to authenticate the primary AoR, which is stored in the MS. If the authentication of the primary AoR succeeds, the MS or the gateway generates a first register message to register the primary AoR of the MS, which has roamed into the visited communication network, with the home communication network. The first register message includes the primary AoR and a corresponding primary location or contact. The first register message may be a SIP register request or REGISTER message if one or more of the home communication networks and the visited communication network are Internet Protocol (IP) based communication networks. The register message is routed from the visited communication network, possibly via a number of intermediate entities, to a Session Initiation Protocol (SIP) registrar associated with the home communication network, which registers the primary AoR with the home communication network. The SIP registrar extracts the primary AoR and the corresponding primary location from the first register message and binds or maps them together in a location database associated with the home communication network.

Thereafter, the SIP registrar sends a registration acknowledgement message to the gateway of the visited communication network. After successful registration of the primary AoR using the first register message, the gateway or the MS may generate a second register message to register a secondary AoR. The second register message includes the secondary AoR and one or more corresponding secondary locations or contacts. The SIP registrar receives the second register message and registers the secondary AoR with the home communication network. Thereafter, the SIP registrar extract the secondary AoR and one or more corresponding secondary locations from the second register message and binds or maps them together in the location database associated with the home communication network. Similarly, for registering each additional secondary AoR with the home communication network, the MS or the gateway associated with the visited communication network generates a register message that contains the additional AoR and one or more corresponding secondary locations or contacts and sends the message to the SIP registrar.

According to the prior art, a single SIP register request can register only one AoR and one or more locations corresponding to that AoR. Therefore, for registering each additional AoR a separate register message has to be generated. This leads to delay in registration of one or more secondary AoRs of the MS. As a result, a session initiated for the MS using a secondary AoR which has not been registered yet, will lapse or fail without connecting to the MS.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an environment in which various embodiments of the present invention can function.

FIG. 2 is a block diagram showing modules of a gateway corresponding to a visited communication network in a system for registering an MS with a home communication network, in accordance with an embodiment of the present invention.

FIG. 3 is a block diagram showing modules of a SIP registrar corresponding to a home communication network in a system for registering an MS with the home communication network, in accordance with an embodiment of the present invention.

FIG. 4 is a flow chart of a method for registering an MS with a home communication network, in accordance with an embodiment of the present invention.

FIG. 5 is a flow chart of a method for registering an MS with a home communication network, in accordance with another embodiment of the present invention.

FIG. 6 is a flow chart of a method for registering a primary AoR and one or more secondary AoRs associated with an MS with the home communication network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PRESENT INVENTION

Before describing in detail embodiments that are in accordance with the present invention, it should be observed that the embodiments reside primarily in combinations of method steps and apparatus components related to registration of a plurality of AoRs of an MS. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional processors and unique stored program instructions that control the one or more processors to implement, in conjunction with certain non-processor circuits, some, most, or all of the functions of method and system for registration of AoRs of an MS described herein. The non-processor circuits may include, but are not limited to, a radio receiver, a radio transmitter, signal drivers, clock circuits, power source circuits, and user input devices. As such, these functions may be interpreted as steps of a method to perform registration of multiple AoRs of an MS using a single request message. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

An object of the invention is to provide a method and system for registering multiple addresses of records for a Mobile Station (MS). Another object of the invention is to provide a method and system for registering primary AoR and one or more secondary AoRs of an MS with a home communication network of the MS in a single register message. Yet another object of the invention is to provide a method and system for reducing the communication overhead and the time required for registering AoRs of an MS with a home communication network.

The above listed objectives are achieved by providing a method and system for registering an MS with a home communication network of the MS when the MS roams into a visited communication network. The method includes communicating a register message from the visited communication network to the home communication network. The register message may be a Session Initiation Protocol (SIP) register request and includes each of a primary AoR and one or more secondary AoRs. The method further includes registering the primary AoR and one or more secondary AoRs with the home communication network.

In an embodiment of the invention, the above listed objectives are achieved by providing a gateway in a system for registering an MS with a home communication network of the MS when the MS roams into a visited communication network. The gateway corresponding to the visited communication network includes an encoding module to encode in a register message each of a primary AoR, a primary location corresponding to the primary AoR, one or more secondary AoRs, and one or more secondary locations. A secondary location corresponds to a secondary AoR. The gateway further includes a communication module to communicate the register message to the home communication network. The register message can be a SIP register request.

In another embodiment of the invention, the above listed objectives are achieved by providing a SIP registrar in a system for registering an MS with a home communication network of the MS when the MS roams into a visited communication network. The SIP registrar includes a decoding module to decode a register message to extract each of a primary AoR, a primary location of the primary AoR, one or more secondary AoRs, and one or more secondary locations. The secondary locations correspond to the one or more secondary AoRs. The SIP registrar further includes a registering module to register each of the primary AoR of the MS and the one or more secondary AoRs of the MS with the home communication network in response to reception of the register message communicated from the visited communication network to the home communication network.

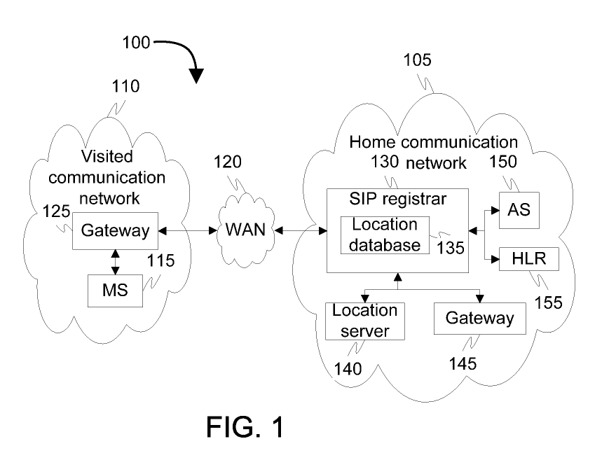

FIG. 1 is a block diagram of a wireless communication system 100 in which various embodiments of the present invention can function. The wireless communication system 100 includes a home communication network 105, a visited communication network 110 and an MS 115 associated with the home communication network 105. It will be apparent to people ordinarily skilled in the art that the wireless communication system 100 may include more than one MS. Each of the home communication network 105 and the visited communication network 110 may be an iDEN™ communication network.

Alternatively, each of the home communication network 105 and the visited communication network 110 may be a Third Generation (3G) communication network. Examples of a 3G communication network may include, but are not limited to a communication network that uses CDMA2000, Wideband-CDMA (W-CDMA), Freedom of Mobile Multimedia Access (FOMA), Wireless Fidelity (WiFi), Worldwide Interoperability for Microwave Access (WiMax), and Universal Mobile Telecommunications System (UMTS). Note that some of these networks are sometimes referred to as 4G communication networks. Further, each of the home communication network 105 and the visited communication network 110 may be one of, but not limited to, an iDEN™ communication network, Global System for Mobile communication (GSM) network, Personal Digital Cellular (PDC) network, Code Division Multiple Access (CDMA) network, and Circuit Switched Data (CSD) network. The home communication network 105 and the visited communication network 110 may be connected via a Wide Area Network (WAN) 120. The WAN 120 may be an Internet Protocol (IP)-based network.

In an embodiment of the present invention, the home communication network 105 may be one of, but not limited to, an iDEN™ communication network, GSM, PDC network, CDMA network and CSD network, and the visited communication network 110 may be a 3G communication network. In this case, the MS 115 uses a primary Identifier (ID) and one or more secondary IDs in the home communication network 105. The primary ID, for example, may be International Mobile Subscriber Identity (IMSI). A secondary ID of the MS 115, for example, may be one of a Universal Fleet Member Identifier (UFMI), a fleet Identifier (ID) and an International Mobile Equipment Identity (IMEI). A primary ID or a secondary ID may also be a Universal Resource Identifier (URI).

The MS 115 may roam into the visited communication network 110. In the visited communication network 110, a primary Address of Record (AoR) is used and corresponds to the primary ID to identify the MS 115, and a secondary AoR is used corresponding to a secondary ID to identify the MS 115. In order to maintain communication with the home communication network 105 when the MS 115 roams into the visited communication network 110, the MS 115 registers the primary AoR and one or more secondary AoRs with the home communication network 105. A communication between the visited communication network 110 and the home communication network 105 may consist of Session Initiation Protocol (SIP) sessions. Example of SIP sessions may include, but are not limited to, Voice over Internet Protocol (VoIP) sessions, phone calls, multimedia distributions and multimedia conferences. The primary AoR may include an IMSI. Each secondary AoR of the MS 115 may include one of a UFMI, a fleet ID and an IMEI. A secondary AoR may also include a second IMSI for the MS 115.

An AoR of an MS may consist of one of a SIP URI, and SIPS URI that points to or can be resolved to a domain having a location database. The AoR may be based on the RFC 3261 protocol, which is available at http://www.ietf org/rfc. The location database maps or binds the AoR with one or more contacts that represent one or more locations or addresses where the MS can be reached. Therefore, if a user initiates a call or a session directed to the AoR of the MS, the call or the session is routed to the location or address where the MS is located based on the mapping or the binding of the AoR with the contacts in the location database.

For registering the MS 115 with the home communication network 105, when the MS 115 roams into the visited communication network 110, the MS 115 generates a register message to register each of the primary AoR and one or more secondary AoRs with the home communication network 105. Alternatively, a gateway 125 associated with the visited communication network 110 may generate the register message. The gateway 125 can be implemented as a proxy such as a Proxy-Call Session Control Function (P-CSCF) in an IP Multimedia Subsystem (IMS). The gateway 125 can also be a proprietary gateway developed to provide interworking between the visited communication network 110 and the WAN 120. Thereafter, in each case, the gateway 125 may route the register message through the WAN 120 to a SIP registrar 130, which is associated with the home communication network 105. The SIP registrar 130 is a server that stores information for an MS associated with the home communication network 105. For example the SIP registrar 130 may store the location of the MS 115 when the MS 115 has roamed into the visited communication network 110. The information is stored with the help of register messages generated by the gateway 125 in the visited communication network 110 or by the MS 115 while it is in the visited communication network 1110. The SIP registrar 130 may be located inside the home communication network 105. Alternatively, the SIP registrar 130 may be located outside the home communication network 105.

The SIP registrar 130 uses the registration request coming from the visited communication network 110 to store an AoR and one or more corresponding locations of the MS 115 in a location database 135 associated with the SIP registrar 130. The location database 135 may be located within SIP registrar 130 or outside SIP registrar 130. The SIP registrar 130 may store the AoR and one or more corresponding locations of the MS 115 in one or more of a location server 140, a gateway 145, an Authentication Server (AS) 150 and Home Location Register (HLR) 155, which are associated with the home communication network 105.

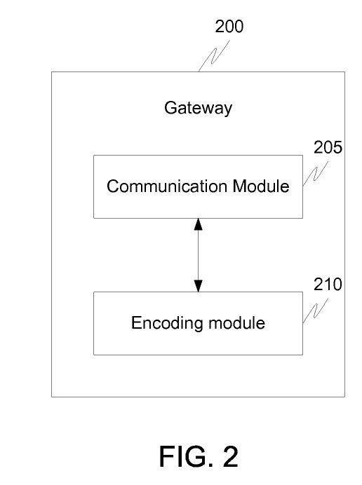

FIG. 2 is a block diagram of a gateway 200 corresponding to the visited communication network 110 in a system for registering the MS 115 with the home communication network 105 in accordance with an embodiment of the present invention. The gateway 200 includes a communication module 205 and an encoding module 210. When the MS 115 roams into the visited communication network 110 from the home communication network 105, the communication module 205 receives the primary AoR from the MS 115. Alternatively, the communication module 205 may receive information from the MS 115 to form the primary AoR. The primary AoR or the information to form the primary AoR may be stored in a Subscriber Identity Module (SIM) inside the MS 115. Additionally, the SIM may store one or more secondary AoRs associated with the MS 115 or the information to form one or more secondary AoRs. Therefore, the communication module 205 may receive one or more secondary AoRs or information to form one or more secondary AoRs from the MS 115.

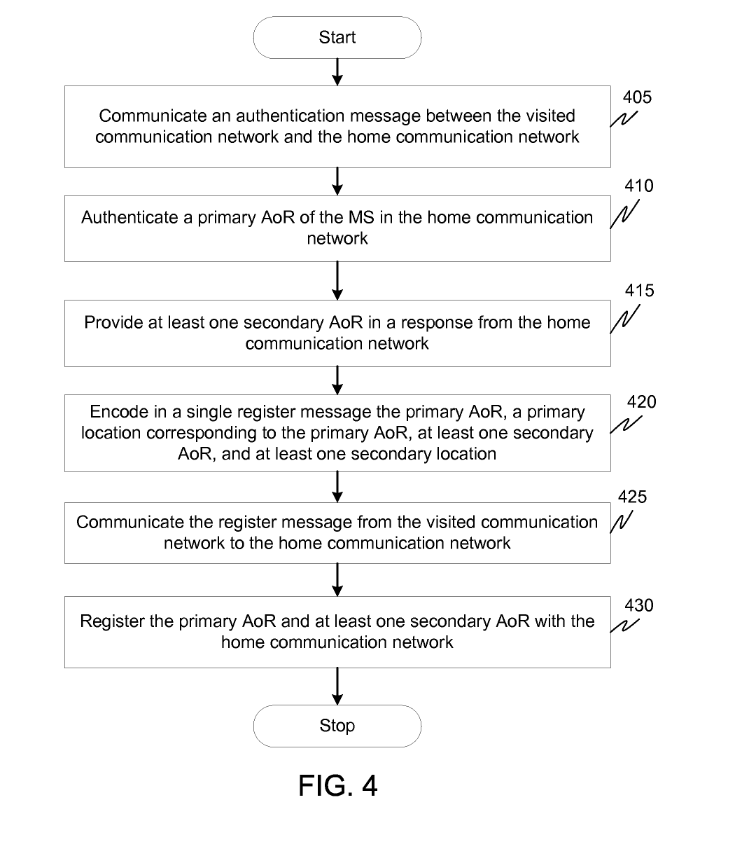

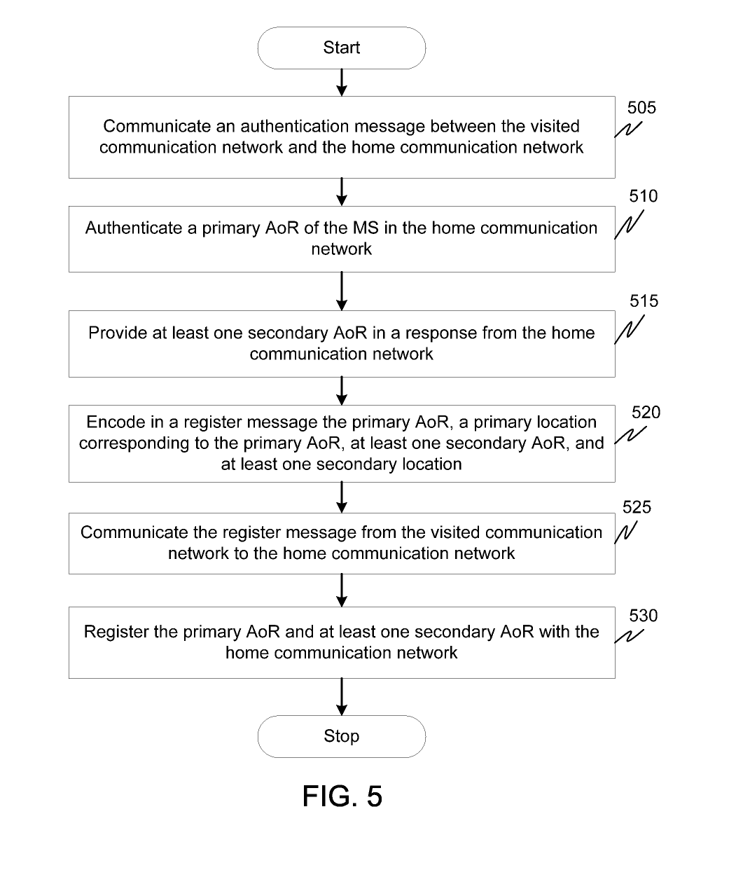

For registration of the primary AoR and the one or more secondary AoRs, the communication module 205 may first authenticate the primary AoR of the MS 115 by communicating one or more authentication messages between the visited communication network 110 and the home communication network 105. The home communication network 105 may modify one or more authentication messages by adding one or more secondary AoRs corresponding to the MS 115 or by adding information for forming one or more secondary AoRs. Therefore, the home communication network 105 may provide one or more secondary AoRs to the communication module 205 through one or more authentication messages or responses. The communication module 205 may forward a secondary AoR or information for forming the secondary AoR to the MS 115. Those of skilled in the art will appreciate that the invention is not limited to the above listed method and may have full scope of the field. This is further explained in conjunction with FIG. 4 and FIG. 5.

Thereafter, the encoding module 210 encodes the primary AoR and a primary location corresponding to the primary AoR in a register message. The register message may be a SIP register request. The encoding module 210 further encodes one or more secondary AoRs and one or more secondary locations in the same register message. A secondary location corresponds to a secondary AoR. This is further explained in conjunction with FIG. 5.

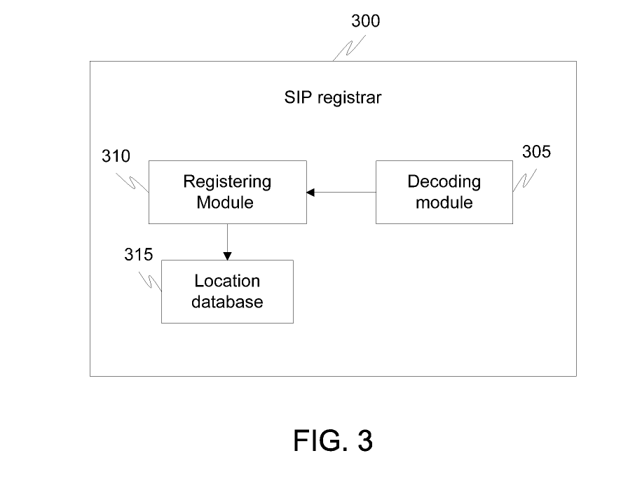

The communication module 205 communicates the register message from the visited communication network 110 through the WAN 120 towards the home communication network 105. The communication module 205 may use known SIP routing methods to route the register message to the SIP registrar 130 of the home communication network 105. This is further explained in conjunction with FIG. 3.

FIG. 3 is a block diagram showing modules of a SIP registrar 300 corresponding to the home communication network 105 in a system for registering the MS 115 with the home communication network 105 in accordance with an embodiment of the present invention. The SIP registrar 300 receives the register message for the MS 115 communicated from the visited communication network 110. The SIP registrar 300 includes a decoding module 305 and a registering module 310. The decoding module 305 decodes the register message in response to reception of the register message from the visited communication network 110. The register message includes each of the primary AoR and one or more secondary AoRs. The register message is decoded to extract each of the primary AoR, the primary location of the primary AoR, one or more secondary AoRs and one or more secondary locations encoded in the register message.

Thereafter, the registering module 310 registers each of the primary AoR of the MS 115 and one or more secondary AoRs of the MS 115 with the home communication network 105. For this, the registering module 310 stores the primary AoR of the MS 115 together with the primary location in a location database 315, thereby establishing a mapping or a binding between the primary AoR and the primary location such that the primary AoR and the primary location are associated with one another. The location database 315 may be located inside or outside the SIP registrar 300. The registering module 310 further stores a secondary AoR together with a corresponding secondary location in the location database 315, thereby establishing a binding or a mapping between the secondary AoR and the corresponding secondary location. This is further explained in conjunction with FIG. 4.

FIG. 4 is a flow chart of a method for registering the MS 115 with the home communication network 105 in accordance with an embodiment of the present invention. When the MS 115 roams into the visited communication network 110, the gateway 200 receives the primary AoR from the MS 115. Alternatively, the gateway 200 may form the primary AoR based on the information received from the MS 115 to form the primary AoR.

The method may optionally first authenticate the MS, using the primary AoR of the MS. To authenticate the primary AoR, the communication module 205 communicates 405 an authentication message between the visited communication network 110 and the home communication network 105. The authentication message may be formatted as a SIP register request. Alternately, a SIP register request may include the authentication message. The gateway 145 in the home communication network 105 may assist to authenticate 410 the primary AoR of the MS 115. This is further explained in detail in conjunction with FIG. 5. The location server 140, the AS 150, and the HLR 155 in the home communication network 105 may also participate in the authentication of the primary AoR. This has been explained in conjunction with FIG. 5.

The authentication messages used for the authentication of the primary AoR provides 415 one or more secondary AoRs for the MS 115. The SIP registrar 300 or another entity in the home communication network 105 may modify one or more of the authentication message by adding one or more secondary AoRs for the MS 115 or by adding sufficient information for the MS 115 that is used by the gateway 125 or another entity in the visited communication network 110 to derive one or more secondary AoRs. For example, the gateway 145 may insert one or more of the UMSI, UFMI, fleet ID and IMEI of the MS in a header in a SIP response message for a SIP authentication request. Therefore, the authentication message provides one or more secondary AoRs for the MS 115. Thereafter, the communication module 205 may receive an authentication message from the home communication network 105, which may include one or more secondary AoRs and authenticates the primary AoR. Each of the primary AoR and one or more secondary AoRs or information for forming a secondary AoR may also be stored in a SIM of the MS 115. In this case, the MS 115 provides each of the primary AoR and one or more secondary AoRs or information for forming a secondary AoR to the communication module 205. This is further explained in detail in conjunction with FIG. 5.

Thereafter, the encoding module 210 encodes 420 each of the primary AoR, the one or more primary locations corresponding to the primary AoR, one or more secondary AoRs and one or more secondary locations in a register message. A secondary location corresponds to a secondary AoR. This is further explained in detail in conjunction with FIG. 5.

To register the MS 115 with the home communication network 105, the communication module 205 communicates 425 the register message from the visited communication network 110 to the SIP registrar 300 associated with the home communication network 105. The register message is a single SIP register request message. The request message includes each of the primary AoR and one or more secondary AoRs of the MS 115. The gateway 200 determines the SIP registrar 300 using a domain name of the home communication network 105. The domain name corresponding to the home communication network 105 is determined based on the primary AoR of the MS 115.

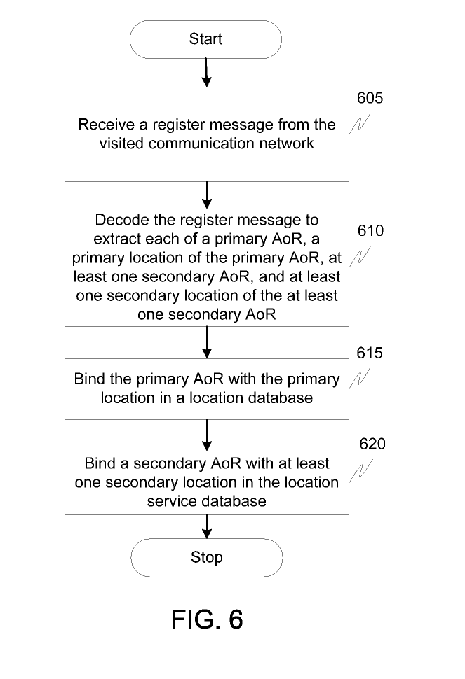

As a result of the reception of the SIP register request message, the registering module 310 in the SIP registrar 300 registers 430 the primary AoR and one or more secondary AoRs of the MS 115 with the home communication network 105. The registering module 310 stores the primary AoR with the one or more primary locations in the location database 315, thereby establishing a mapping or binding between the primary AoR and the one or more primary locations. Similarly, the registering module 310 stores a secondary AoR and at least one corresponding secondary location in the location database 315, thereby establishing a mapping or binding between a secondary AoR and the corresponding secondary location. Thus, the AoRs and locations are associated with one another. This is further explained in detail in conjunction with FIG. 6.

After the primary AoR and one or more secondary AoRs are registered with the home communication network 105, a session initiated from the home communication network 105 for the MS 115 roaming in the visited communication network 110 can be routed to the MS 115. Further, as the register message includes each of the primary AoR and one or more secondary AoRs, multiple AoRs of the MS 115 can be registered with the home communication network 105 in a single SIP register request, thereby reducing the communication overhead and delay. Therefore, a session initiated for the MS 115 using a secondary AoR will be routed to the corresponding secondary location for the MS 115, and the session will not lapse due to lag in registration of a secondary AoR.

FIG. 5 is a flow diagram of a method for registering the MS 115 with the home communication network 105 in accordance with another embodiment of the present invention. The communication module 205 in the gateway 200 optionally first communicates 505 an authentication message between the visited communication network 110 and the home communication network 105 to authenticate the primary AoR received from the MS 115. Thereafter, one or more of the gateway 200, the location server 140 and the AS assist to authenticate 510 the primary AoR of the MS 115 in the home communication network 105.

If the authentication of the primary AoR is successful, the home communication network 105 communicates an authentication message, which is an authentication response message to the visited communication network 110, through the communication module 205 in the gateway 200 associated with the visited communication network 110. The authentication response message communicated to the gateway 200, for example, may be a “200 OK” message. However, if the authentication of the primary AoR is unsuccessful, then the home communication network 105 communicates an authentication failed message to visited communication network 110 through the communication module 205 in the gateway 200. The authentication failed message, for example, may be a “401 Unauthorized” message.

The authentication message received by the gateway 200 in the visited communication network 110 authenticates the primary AoR. Further, the authentication message provides 515 one or more secondary AoRs associated with the MS 115 or information corresponding to one or more secondary AoRs to the visited communication network.

Alternatively or in parallel, the MS 115 may provide one or more secondary AoRs to the gateway 200 in which case step 505, step 510 and step 515 may not be performed. The MS 115 may have recorded one or more secondary AoRs in its memory, when it was previously operating in the home communication network 105. One or more secondary AoRs of the MS 115 may also have been stored in the SIM or memory of the MS 115 by a service manufacturer who manufactured the MS 115 or by the service provider of the MS 115. Alternately, an operator of the MS 115 may use an over the air programming command from the home communication network 105 to store information corresponding to one or more secondary AoRs in the SIM or the memory of the MS 115. In another embodiment of the present invention, one of the MS 115 and the gateway 200 may access a database that stores one or more secondary AoRs associated with the MS 115. The database may reside on a server associated with the home communication network 105. The database is queried using the primary AoR to obtain one or more secondary AoRs associated with the MS 115. The database may also be queried using a registered AoR other than the primary AoR. The registered AoR, for example, may be an AoR corresponding to the IMEI of the MS 115. In another embodiment of the invention, the gateway 200 uses one or more queries to obtain one or more secondary AoRs from the home communication network 105. The one or more queries may use proprietary messages or they may be standard database queries.

After the communication module 205 receives the authentication message or determines one or more secondary AoRs by other means such as the means described above, the communication module 205 in the gateway 200 communicates the primary AoR and one or more secondary AoRs to the encoding module 210. Thereafter, the encoding module 210 encodes 520 each of the primary AoR, the primary location corresponding to the primary AoR, one or more secondary AoRs, and one or more secondary locations into a single register message. The register message may be a SIP register request message. The encoding module 210 may encode the primary AoR and one or more secondary AoRs in a ‘To’ header of the register message. The encoding module 210 may further encode the primary location corresponding to the primary AoR and one or more secondary locations corresponding to one or more secondary AoRs in one or more ‘Contact’ headers of the register message. When a register message includes a plurality of ‘Contact’ headers, then the primary location may be stored in a first ‘Contact’ header and one or more secondary locations may be stored in one or more additional ‘Contact’ headers of the register message.

In an embodiment of the invention, the encoding module 210 may encode the primary AoR in the ‘To’ header of the register message. Further, the encoding module 210 encodes the primary location or contact; one or more secondary AoRs; and one or more secondary locations in one or more ‘Contact’ headers of the register message. Further, the encoding module 210 may encode a parameter for a primary or secondary location that contains all or part of a specific primary or secondary AoR to indicate that the location corresponds to the specific AoR. In particular, the encoding module 210 may indicate in the register message that a secondary location corresponds to a secondary AoR by adding the secondary AoR as a parameter to the secondary location. Therefore, one or more ‘Contact’ headers of the register message include the primary location or contact, which corresponds to the primary AoR in the ‘To’ header of the register message; and one or more secondary locations or contacts. Each secondary location may have a parameter that includes the secondary AoR corresponding to the secondary location. As an example of the embodiment given above, a SIP register request includes the primary AoR, a first secondary AoRs and a second secondary AoR. The ‘To’ header in the SIP register request includes the primary AoR and a first ‘Contact’ header includes the primary location. Further, a second ‘Contact’ header includes a first secondary location and a corresponding parameter that includes the first secondary AoR, and a third ‘Contact’ header includes a second secondary location and a corresponding parameter that includes the second secondary AoR.

Thereafter, the communication module 205 communicates 525 the register message from the visited communication network 110 to SIP registrar 300 associated with the home communication network 105. The registering module 310 registers 530 the primary AoR and one or more secondary AoRs and the corresponding locations in the home communication network 105. The method of registering is further explained in detail in conjunction with FIG. 6.

FIG. 6 is a flow chart of a method for registering the primary AoR and one or more secondary AoRs associated with the MS 115 with the home communication network 105 in accordance with an embodiment of the present invention. The SIP registrar 300 receives 605 the register message communicated by the communication module 205 from the visited communication network 110. The decoding module 305 decodes 610 the register message to extract each of the primary AoR, the primary location of the primary AoR, one or more secondary AoRs, and one or more secondary locations. The decoding module 305 also determines from the register message that a secondary location corresponds to a secondary AoR.

Thereafter, the registering module 310 binds or maps 615 the primary AoR with the primary location in the location database 315. The primary location is a first location of the MS 115, where the MS 115 can be contacted directly in the visited communication network 110. Further, as the primary AoR is bound with the primary location in the location database 315, therefore a session initiated in the home communication network 105 using the primary AoR is routed to the primary location of the MS 115 in the visited communication network 110. For example, the register message may include the primary AoR in the ‘To’ header and a cell number or an Internet Protocol (IP) address as the primary location of the MS 115 in the visited communication network 110 in the ‘Contact’ header. The registering module 310 binds or maps the primary AoR with the cell number or the IP address in the location database 315. Therefore, a session initiated in the home communication network 105 for the MS 115 using the primary AoR is routed to the cell number or the IP address associated with the MS 115.

The registering module 310 binds or maps 620 a secondary AoR with one or more secondary locations in the location database 315. A secondary location is a second location where the MS 115 can be contacted in the visited communication network 110. As a secondary AoR is bound with one or more secondary locations in the location database 315, a session initiated in the home communication network 105 using the secondary AoR is routed to one or more secondary locations of the MS 115 in the visited communication network 110. For example, the register message may include in one or more ‘Contact’ headers a telephone number as a first secondary location of the MS 115 with a parameter added to the telephone number indicating that the telephone number corresponds to a first secondary AoR and an email addresses as a second secondary location of the MS 115 with a parameter added to the email addresses indicating that the email addresses corresponds to a second secondary AoR. The registering module 310 binds or maps the first secondary AoR with the telephone number and the second secondary AoR with the email address in the location database 315. The location database 315 may be located outside the home communication network 105 and may be located inside the home communication network 105. The location database 315 may be accessible to one or more elements of the home communication network 105. Therefore, a session initiated in the home communication network 105 for the MS 115 using the first secondary AoR can be routed to the telephone number associated with the MS 115. Similarly, a session initiated in the home communication network 105 for the MS 115 using the secondary AoR can be routed to the email address associated with the MS 115.

The bindings and mapping between the primary AoR and the primary location and the binding and mapping between a secondary AoR and one or more secondary locations may also be stored in a location server in the home communication network 105. The location server, for example, may be a Home Location Register (HLR).

SIP registrar 300 can be queried with a primary AoR or a secondary AoR corresponding to the MS 115 to obtain the one or more locations or contacts registered for that AoR. When queried with an AoR, the SIP registrar 300 further queries the location database 315 and obtains locations or contacts bound with the AoR queried for. The location database 315 is configured to provide one or more locations when queried with the corresponding AoR. Alternatively, the home communication network 105 may itself query the location database 315 with a primary AoR or one a secondary AoR to obtain the one or more locations or contacts registered for that AoR. The locations or contacts bound with the AoR can then be used to route one or more sessions initiated for the MS 115 using the AoR in the home communication network 105. For example, a session or a call is initiated for MS 115 in the home communication network 105 using a secondary ID or secondary AoR to identify the MS 115. The home communication network 105 may then query the SIP registrar 300 with the secondary AoR to obtain a corresponding secondary location(s) or contact(s) registered for the secondary AoR to route the session or the call. The SIP registrar 300 further queries the location database 315 for locations or contacts bound to the secondary AoR and provides the location to the home communication network 105. Thereafter, the home communication network 105 routes the session or the call through the gateway 200 to the MS 115 using the one or more secondary location or contact obtained from the location database 315.

In an example of the present invention, the MS 115 roams from the home communication network 105 to a visited communication network 110. The home communication network 105 is an iDEN™ communication network, and the visited communication network 110 is a 3G communication network. The communication between the home communication network 105 and the visited communication network 110 is enabled through WAN 120.

The MS 115 uses a primary ID and one or more secondary IDs in the home communication network 105. The MS 115 may roam into the visited communication network 110. In the visited communication network 110, the primary ID of the MS 115 is identified as a primary AoR, and a secondary ID of the MS 115 is identified as a secondary AoR. In order to maintain communication with the home communication network 105 when the MS 115 roams into the visited communication network 110, the MS 115 registers the primary AoR and one or more secondary AoRs with the home communication network 105. A communication between the visited communication network 110 and the home communication network 105 may consist of SIP sessions.

For registering the MS 115 with the home communication network 110 when the MS 115 roams into the visited communication network 110, the MS 115 generates a single register message to register the primary AoR and one or more secondary AoRs with the home communication network 105 as well as one or more locations or contacts for each AoR. Alternatively, the gateway 125 associated with the visited communication network 110 may generate the single registration message. Thereafter, the gateway 125 may route the register message through the WAN 120 to the SIP registrar 130, which is associated with the home communication network 105. The SIP registrar 130 may be located inside the home communication network 105. Alternatively, the SIP registrar 130 may be located outside the home communication network 105.

The SIP registrar 130 uses the register message to decode the primary AoR, one or more secondary AoRs and one or more corresponding locations or contacts of the MS 115 and bind or maps them in a location database 135 associated with the SIP registrar 130. The location database 135 may be located outside the SIP registrar 130. The SIP registrar 130 may instruct or cause the location server 140 associated with the home communication network 105 to store each of the AoRs and one or more corresponding locations of the MS 115.

Thereafter, the SIP registrar 130 can be queried with a primary AoR or a secondary AoR corresponding to the MS 115 to obtain the one or more locations or contacts registered for the AoR. The SIP registrar 130 further queries the location database 135 and obtains locations or contacts bound with the AoR queried for. Alternatively, the home communication network 105 may query the location database 135 with a primary AoR or a secondary AoR to obtain the one or more locations or contacts registered for and bound to the AoR. The locations or contacts bound to the AoR can then be used to route one or more sessions initiated for the MS 115 using the AoR from the home communication network 105. For example, a session or a call is initiated for MS 115 in the home communication network 105 using a secondary ID to identify the MS 115. The home communication network 105 may then query the SIP registrar 130 with the secondary AoR corresponding to the secondary ID. The home communication network 105 may derive a secondary AoR, which may be derived from the secondary ID by adding a known host name or by using a database lookup. The query is made to obtain a corresponding secondary location or contact registered for the secondary AoR to route the session or the call. The SIP registrar 130 further queries the location database 135 for a location or contact bound to the secondary AoR and provides the corresponding one or more locations to the home communication network 105. Thereafter, the home communication network 105 route the session or the call through the gateway 125 to the MS 115 using the one or more secondary locations or contacts obtained from the location database 135.

Various embodiments of the invention provide methods and systems for registering an MS with a home communication network when the MS roams into a visited communication network. A primary AoR and one or more secondary AoRs associated with the MS are expediently registered with the home communication network. Therefore, a communication session initiated from the home communication network for the MS using one of the primary AoR and one or more secondary AoRs can be routed to the MS roaming in the visited communication network. Further, as the primary AoR and one or more secondary AoRs are registered in a single register message, the communication overhead and the time required for registering AoRs of the MS with the home communication network is reduced. As a result of this, a communication session initiated for the MS from the home communication using one or more secondary AoRs will be more reliable. Additionally, an AoR of the MS can be registered such that the MS can be reached at one or more direct location using a primary or a secondary AoR.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method of registering a Mobile Station (MS) with a home communication network of the MS when the MS roams into a visited communication network, the method comprising:
communicating a register message from the visited communication network to the home communication network, wherein the register message is a Session Initiation Protocol (SIP) register request, the register message comprises each of a primary Address of Record (AoR) and at least one secondary AoR; and
registering the primary AoR and the at least one secondary AoR with the home communication network.

2. The method of claim 1 further comprising:
communicating an authentication message between the visited communication network and the home communication network; and
authenticating the primary AoR of the MS in the home communication network, wherein the authenticating provides the at least one secondary AoR to the MS.

3. The method of claim 1 further comprising:
providing the at least one secondary AoR to the visited communication network in a response from the home communication network to the visited communication network.

4. The method of claim 1, wherein the primary AoR comprises the International Mobile Subscriber Identity (IMSI) of the MS.

5. The method of claim 1, wherein the at least one secondary AoR comprises at least one of a Universal Fleet Member Identifier (UFMI), a fleet ID, and an International Mobile Equipment Identity (IMEI).

6. The method of claim 1, wherein communicating comprises encoding in the register message each of:
the primary AoR;
the at least one secondary AoR;
a primary location corresponding to the primary AoR; and
at least one secondary location, wherein a secondary location corresponds to a secondary AoR.

7. The method of claim 1 further comprising:
decoding the register message to extract each of:
the primary AoR;
the at least one secondary AoR;
a primary location of the primary AoR; and
at least one secondary location;
binding the primary AoR with the primary location; and
binding a secondary AoR with a secondary location.

8. The method of claim 1, wherein each of the home communication network and the visited communication network correspond to an Integrated Digitally Enhanced Network (iDEN™) communication network.

9. The method of claim 1, wherein the home communication network corresponds to an iDEN™ system and the visited communication network corresponds to a Third Generation (3G) communication network.

10. The method of claim 1, wherein the visited communication network corresponds to an iDEN™ system and the home communication network corresponds to a Third Generation (3G) communication network.

11. The method of claim 1, wherein the MS stores each of the primary AoR and the at least one secondary AoR.

12. The method of claim 11, wherein the MS provides each of the primary AoR and the at least one secondary AoR in the register message.

13. The method of claim 1, wherein a gateway provides each of the primary AoR and the at least one secondary AoR in the register message.

14. A gateway in a system for registering a mobile station (MS) with a home communication network of the MS when the MS roams into a visited communication network, the gateway corresponding to the visited communication network comprising:
an encoding module to encode in a register message each of:
a primary Address of Record (AoR);
a secondary AoR;
a primary location corresponding to the primary AoR; and
a secondary location corresponding to the secondary AoR; and
a communication module to:
communicate the register message to the home communication network, wherein the register message is a Session Initiation Protocol (SIP) register request.

15. The gateway of claim 14, wherein the communication module communicates an authentication message between the visited communication network and the home communication network to authenticate the primary AoR.

16. The gateway of claim 14, wherein the communication module obtains the secondary AoR in a response from the home communication network.

17. A SIP registrar in a system for registering a mobile station (MS) when the MS roams into a visited communication network, the SIP registrar comprising:
a decoding module to decode a register message communicated from the visited network to the SIP registrar to extract each of:
a primary Address of Record (AoR);
at least one secondary AoR;
a primary location of the primary AoR; and
at least one secondary location, wherein the at least one secondary location corresponds to the at least one secondary AoR; and
a registering module to register each of the primary AoR and the at least one secondary AoR in response to decoding the register message.

18. The SIP registrar of claim 17, wherein the registering module is further configured to:
bind the primary AoR with the primary location in a location database; and
bind the at least one secondary AoR with the at least one secondary location corresponding to the at least one secondary AoR in the location database.

19. The SIP registrar of claim 18 further comprising the location database.

20. The SIP registrar of claim 18, where the location database is configured to provide the at least one secondary location when queried with the corresponding at least one secondary AoR.
